(19) United States
(12) Patent Application Publication
(10) Pub. No.: US 2021/0387844 A1
(43) Pub. Date: Dec. 16, 2021

(54) Touchless Valve

(71) Applicant: ValidFill LLC, Bradenton, FL (US)

(72) Inventors: Jeremy Wade, Bradenton, FL (US); Tyler Wampler, E. Parish, FL (US); Kolby Wade, Bradenton, FL (US); Loren Ostema, Sarasota, FL (US); Paul Wade, E. Bradenton, FL (US)

(21) Appl. No.: 17/304,000

(22) Filed: Jun. 11, 2021

Related U.S. Application Data
(60) Provisional application No. 62/705,140, filed on Jun. 12, 2020.

(51) Int. Cl. B67D 1/08; B67D 1/12; G01V 8/12

(52) U.S. Cl. CPC B67D 1/0888; G01V 8/12; B67D 1/1277

(57) ABSTRACT

Embodiments relate to a touchless valve device including an emitter configured to emit an emission. The device includes a receiver configured to detect the emission. The receiver is positioned within an emission path of the emitter. The receiver is configured to, upon detection of the emission by the receiver, the receiver generates a first signal. The receiver is configured to generate a second signal when the receiver does not detect the emission. The receiver is configured to transmit the first signal and/or the second signal to a processor that controls a valve.

### CROSS-REFERENCE TO RELATED APPLICATIONS

This application is related to and claims the benefit of U.S. provisional application 62/705,140, filed on Jun. 12, 2020, the entire contents being incorporated herein by reference.

### FIELD OF THE INVENTION

Embodiments relate to a touchless valve device that can be used with a beverage dispensing unit.

### BACKGROUND OF THE INVENTION

Known beverage dispensing systems are limited in that a user is required to physically make contact (either with the user hand or the user's beverage container) with a portion of the beverage dispensing system to cause it to disburse beverage and/or beverages. Examples of known means for disbursing beverage are push-button (a user depresses a button with their finger), pull-lever (a user pulls a lever with their hand), and push-lever (a user depresses a lever with their beverage container). Making physical contact with the beverage dispensing apparatus can present an unsanitary environment.

Embodiments disclosed herein are directed toward overcoming one or more of the disadvantages discussed above.

### SUMMARY OF THE INVENTION

Embodiments relate to a touchless valve device that can be used with a beverage dispensing unit. The touchless valve device is placed into communication with a valve of the beverage dispensing unit so as to allow the device to control operation of the valve. The touchless valve device can be configured as an interrupter sensor having an emitter and a receiver that generates command signals for the valve based on whether the receiver detects emissions from the emitter. A user can use their finger or some other object to obstruct a path between the receiver and the emitter to cause the device to transmit a desired signal to the valve. Notably, no physical contact between the user (or user's container) and the beverage dispensing unit is required. The device can be installed on existing beverage dispensing units with ease.

Benefits of the device include: 1) simple operation of breaking or not breaking the plane between the receiver and the emitter; 2) the ability to utilize almost any object to break the plane (e.g., finger, credit card, phone, pen, etc.); 3) the beverage dispensing unit behaves the same as if a push-button, a pull-lever, or a push-lever were used—i.e., no features of the existing dispensing unit have to be modified; 4) installation of a touchless valve device can be completed within two minutes; 5) installation can be done without removal of existing components of the dispensing unit; 6) the device is operable with existing valves of the dispensing unit and can; and 7) the touchless valve device can accommodate stock soda labels—e.g., not special labels are required.

In an exemplary embodiment, a touchless valve device includes an emitter configured to emit an emission. The device includes a receiver configured to detect the emission. The receiver is positioned within an emission path of the emitter. The receiver is configured to, upon detection of the emission by the receiver, the receiver generates a first signal. The receiver is configured to generate a second signal when the receiver does not detect the emission. The receiver is configured to transmit the first signal and/or the second signal to a processor that controls a valve.

In some embodiments, the emitter includes an optical generator configured to generate an optical emission, and the receiver includes an emission sensor configured to detect the optical emission.

In some embodiments, the optical generator generates an emission within the infrared spectrum.

In some embodiments, the optical generator generates an emission that includes radiation at 940 nm.

In some embodiments, the touchless valve device includes a central member having an emitter end and a receiver end. The emitter end is configured to house the emitter. The receiver end is configured to house the receiver.

In some embodiments, the emitter end includes a protrusion extending from the central member. The receiver end includes a protrusion extending from the central member.

In some embodiments, the touchless valve device includes a central member having an emitter end and a receiver end, the emitter end configured to house the emitter, and the receiver end configured to house the receiver. The emitter end includes a protrusion extending from the central member configured to house the optical generator. The receiver end includes a protrusion extending from the central member configured to house the emission sensor.

In some embodiments, the touchless valve device includes a planar member extending from the central member.

In some embodiments, the device includes a control module configured to receive the first signal and/or the second signal from the receiver, wherein the control module transmits the first signal and/or the second signal to the processor that controls the valve as opposed to the receiver transmitting the first signal and/or the second signal to the processor that controls the valve. The control module includes a timer mechanism configured to: delay transmission of the first signal and/or the second signal to the processor; and/or set a time limit for the operational state of the valve.

In some embodiments, the control module, upon receiving the first signal and/or the second signal from the receiver, waits a predetermined period of time before transmitting the first signal and/or the second signal to the processor.

In some embodiments, the control module, upon receiving the first signal and/or the second signal from the receiver, waits before transmitting the first signal and/or the second signal to the processor. This may allow the beverage consumer time to anticipate receipt of the beverage. In some embodiments this waiting delay may range between 10 ms to 150 ms.

In some embodiments, the control module, after transmitting the first signal and/or the second signal from the receiver, waits a predetermined period of time before transmitting a subsequent first signal and/or second signal generated by the receiver to the processor.

In some embodiments, the control module, after transmitting the second signal to the processor, transmits a first signal to the processor when no first signal has been generated by the receiver within a predetermined time period after the control module transmitted the second signal to the processor.

In some embodiments, the predetermined time period ranges from 20 seconds to 30 seconds.

In some embodiments, the device includes an operational status indicator configured to indicate the operational status of the valve.

In some embodiments, the operational status of the valve is closed when the first signal is being transmitted to the processor that controls the valve. The operational status of the valve is open when the second signal is being transmitted to the processor that controls the valve.

In some embodiments, the operational status indicator includes at least one illuminator.

In an exemplary embodiment, a touchless valve beverage dispensing unit includes a beverage dispensing unit including a processor configured to control a valve, wherein the valve is configured to control flow of beverage. The unit includes a touchless valve actuator. The actuator includes an emitter configured to emit an emission. The actuator includes a receiver configured to detect the emission, the receiver positioned within an emission path of the emitter. The receiver is configured to, upon detection of the emission by the receiver, the receiver generates a first signal. The receiver generate a second signal when the receiver does not detect the emission. The receiver transmit the first signal and/or the second signal to the processor that controls the valve.

In some embodiments, upon receiving the first signal, the processor generates a command signal to close the valve.

In some embodiments, upon receiving the second signal, the processor generates a command signal to open the valve.

Further features, aspects, objects, advantages, and possible applications of the present invention will become apparent from a study of the exemplary embodiments and examples described below, in combination with the Figures, and the appended claims.

### BRIEF DESCRIPTION OF THE DRAWINGS

The above and other objects, aspects, features, advantages and possible applications of the present innovation will be more apparent from the following more particular description thereof, presented in conjunction with the following drawings. Like reference numbers used in the drawings may identify like components.

FIG. 1 shows an exemplary touchless valve device.

FIG. 2 shows various views of an exemplary touchless valve device.

FIG. 3 shows exemplary touchless valve devices installed on a beverage dispensing unit.

FIG. 4 shows an exemplary block diagram representative of a system architecture that may be used for the touchless valve device when used to control a valve of the beverage dispensing unit.

### DETAILED DESCRIPTION OF THE INVENTION

The following description is of exemplary embodiments that are presently contemplated for carrying out the present invention. This description is not to be taken in a limiting sense, but is made merely for the purpose of describing the general principles and features of various aspects of the present invention. The scope of the present invention is not limited by this description.

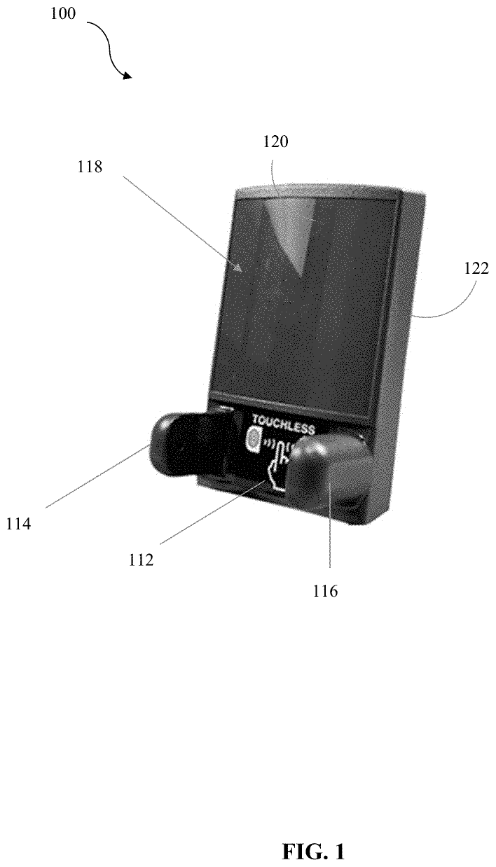

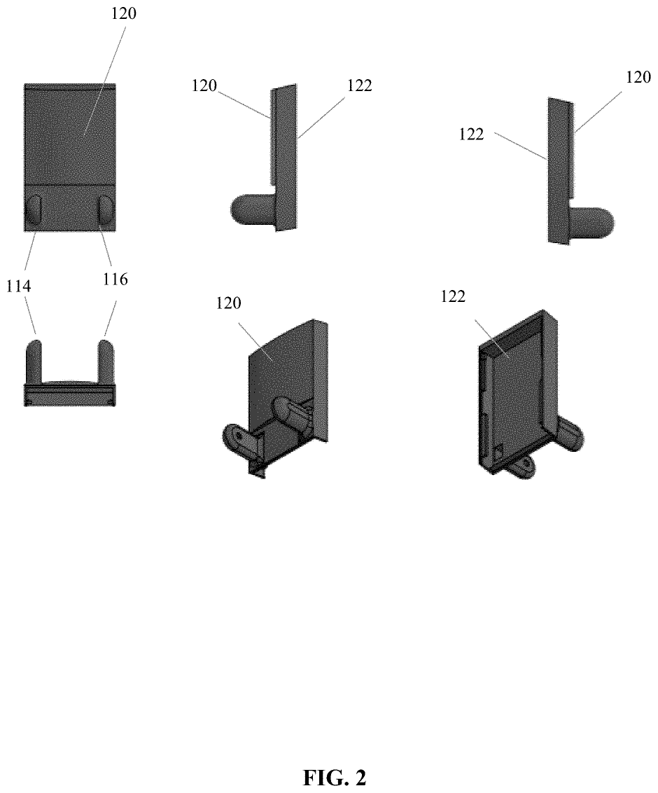

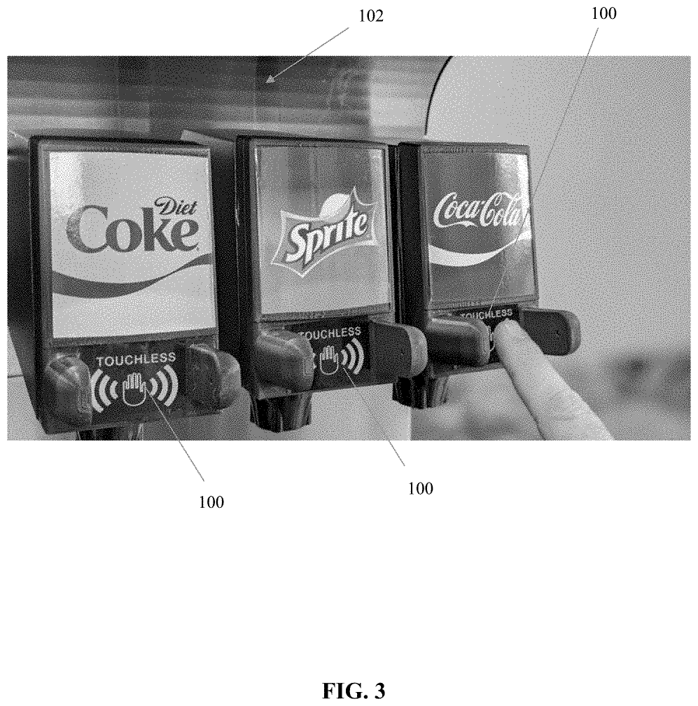

Referring to FIGS. 1-3, embodiments relate to a touchless valve device 100. The touchless valve device 100 facilitates actuation of a valve in connection with the touchless valve device 100 via a motion, movement, placement, or gesturing of an object in relation to the touchless valve device 100.

It is contemplated for the touchless valve device 100 to be used with a beverage dispensing unit 102, but it can be used with any apparatus that includes the use of a valve 104 controlled by a user. In exemplary embodiments, the touchless valve device 100 can be used with a beverage dispensing unit 102 to allow a user to controllably dispense beverage therefrom using a user's finger (or some other object) to control operation of a valve 104 of the beverage dispensing unit 102 but without physically touching the valve 104 or any portion of the beverage dispensing unit 102.

The touchless valve device 100 can be configured as an interrupter sensor. For instance, the device 100 can include at least one emitter 106 and at least one receiver 108, each emitter 106 being in line with a respective receiver 108 so that emission from the emitter 106 is incident upon its respective receiver 108. When the receiver 108 is receiving an emission from its respective emitter 106, a first condition is met. When the receiver 108 is not receiving an emission from its respective emitter 106 (or at least cannot detect said emission), a second condition is met. This binary condition can be used for switching a valve 104 that is in connection with the device 100. For instance, when the receiver 108 is receiving an emission from the emitter 106, a signal can be generated by the device 100 to cause the valve 104 to close. When the receiver 108 is not receiving an emission from the emitter 106, a signal can be generated by the device 100 to cause the valve 104 to open. It is understood that receiving an emission can be used to open the valve 104 and not receiving the emission can be used to close the valve 104.

The emitter 106 can be a device configured to emit a signal (e.g., light, sound, etc.). The receiver 108 can be a device configured to sense the emission from the emitter 106 (e.g., light sensor, sound sensor, etc.). For instance, the emitter 106 can be an optical generator (e.g., a light emitting diode (LED) or some other illuminator). It is contemplated for the emitter 106 to emit light of a specific frequency, or range of frequencies, by which the receiver 108 is intended to detect. Thus, the emitter 106 can be an infrared light generator (e.g. emit radiation within the infrared spectrum). The emitter 106 can emit radiation at or near 940 nm, for example. The emitter 106 can be configured to oscillate at a predetermined frequency to facilitate discrimination processing of the detected signal by the receiver 108. Additional firmware or software adjustments can be made to account for indirect or direct sunlight interfering with the receiver 108. The receiver can be an infrared light photodetector or photodiode (e.g., detect radiation at or near 940 nm) configured to detect the infrared light being emitted at the predetermined frequency; however, in a preferred embodiment, the emitter and the receiver share a common processor. Although further references in this disclosure refer to use of distinct processors, those of skill in the art will recognize that advantages in response time may be achieved through use of a single processor. Each of the emitter 106 and the receiver 108 can include a processor with an associated memory. The memory can be non-transitory, non-volatile memory configured to store program instructions thereon, and the processor(s) execute operations based on those instructions. The emitter's 106 processor can be configured to cause the optical generator to emit light at a specified frequency, or range of frequencies. The receiver's 108 processor can be configured to cause the photodetector to generate a first signal when it detects the emission from the emitter 106 and generate a second signal when it does not detect the emission from the emitter 106. The first signal can be used as an indicator that no dispensing is desired, and thus be a signal that the valve 104 should be closed. The second signal can be used as an indicator that dispensing is desired, and thus be a signal that the valve 104 should be open.

The device 100 can be placed in communication (hardwired or wireless) with a valve 104 of the beverage dispensing unit 102. It is contemplated for there to be an individual device 100 for each individual valve 104 of the beverage dispensing unit 102. Thus, the beverage dispensing unit 102 can have a plurality of valves 104, each valve 104 controlling disbursement of a different type of beverage. An individual device 100 can be placed into communication with an individual valve 104 so that a plurality of devices 100 can be used to control disbursement of beverage from the plurality of valves 104. A hardwired connection can be achieved via electrical interconnects between the processor of the device 100 and a processor of the valve 104 or unit 102. A wireless connection can be achieved via use of a transceiver of the device 100 and a transceiver of the valve 104 or unit 102. Signals generated by the device(s) 100 can be received by the processor(s) of the valve(s) 104 or unit 102, which can be converted to command signals to operate the valve(s) 104.

As will be explained, other conditions may apply, but generally when a first signal is received by a valve 104, the processor of the valve 104 or unit 102 causes the valve 104 to close and/or remain closed until another condition is met. Generally, when a second signal is received by a valve 104, the processor of the valve 104 or unit 102 causes the valve 104 to open and/or remain open until another condition it met.

As noted herein, the device 100 can be configured as an interrupter sensor. When the device 100 is in use, the emitter 106 is emitting an emission to the receiver 108 so that the receiver 108 is detecting the emission and its processor is causing the device 100 to generate a first signal. The first signal is received by the processor of the valve 104 or unit 102, wherein the processor of the valve 104 or unit 102 converts the first signal to a command signal instructing the valve 104 to close and/or remain closed. When a user desires disbursement from a particular valve 104, a user blocks the signal being transmitted from the emitter 106 to the receiver 108 of the device 100 associated with that valve 104. This can be achieved by placing a finger or some other object between the emitter 106 and the receiver 108 so as to obstruct the path between the emitter 106 and the receiver 108, thereby preventing the emission of the emitter 106 from being received by the receiver 108 (or at least prevent or inhibit the receiver's 108 ability to detect the emission). The receiver 108 not being able to detect the emission causes the processor of the receiver 108 to generate the second signal. The second signal is received by the processor of the valve 104 or unit 102, wherein the processor of the valve 104 or unit 102 converts the second signal to a command signal instructing the valve 104 to open and/or remain open.

The device 100 can be configured to be installed on a front face of a beverage dispensing unit 102. For instance, the unit 102 can include a plurality of dispensing heads 110, each dispensing head 110 dedicated to dispensing a certain type of beverage. Each dispensing head 110 also includes a valve 104 controlling flow of its respective beverage from a reservoir of the unit 102 through a nozzle and into a user's container. The unit 102 can have a front display having a plurality of labels, each label associated with a valve 104 controlling a particular type of beverage. A device 100 can be installed in a front face of the front display at or near a label. Thus, a first device 100 can be installed at or near a first label and placed in communication with a first valve 104 for control of first beverage from the first valve 104, a second device 100 can be installed at or near a second label and placed in communication with a second valve 104 for control of second beverage from the second valve 104, etc. Each device 100 can be installed using fasteners (e.g., screws), adhesive, or suitable securement means.

In addition, or in the alternative, the device 100 has a planar member 112 that includes the label(s) for the beverages. Details of the planar member 112 and how it can be used for such purposes are discussed later.

Conventional beverage dispensing units can have push-button style controls to operate the valve(s) 104. The device 100 can be place on top of the push-button style control. Thus, while is it possible to do so, there is no need to remove the push-button style control.

The device 100 can be made of rigid material, such a plastic, ceramic, metal, etc. The device 100 can include a central member 112 having an emitter end 114 and a receiver end 116. The emitter end 114 can house the emitter 106 and associated components, and also include a protrusion extending from the central member 112. The receiver end 116 can house the receiver 108 and associated components, and also include a protrusion extending from the central member 112. The emitter protrusion can be used to house the emission generator, and the receiver protrusion can be used to house the emission sensor (e.g., photodetector or photodiode) so that the emission generator and the emission sensor are aligned and that a geometric plane is formed between the two. This allows there to be an emission path to be formed between the emission generator and the emission sensor and provides a volume of space by which a user can selectively obstruct that path without having to physically touch the device 100 or unit 102.

The device 100 can include a planar member 118 extending from the central member 112. The planar member 118 can be square, rectangular, triangular, circular, etc. It is contemplated for the planar member 118 to be configured as a place for a label (e.g., a beverage label). The planar member 118 have a front surface 120 and a rear surface 122. The label is placed on the front surface 120. When installed on a beverage unit 102, the rear surface 122 faces and abuts against the front face of the unit 102. Adhesive can be placed on the rear surface 122 and/or a portion of the central member 112 to facilitate securement of the device 100 to the unit 102. In addition, or in the alternative, fasteners can be used to secure the device 100 to the unit 102.

The device 100 can include a battery unit or be placed into electrical connection with the power source for the unit 102 after being secured thereto.

In use, and after the device 100 is installed on the unit 102, the emitter 106 emits an emission to the receiver 108. Upon detection of the emission by the receiver 108, the processor of the receiver 108 to generates the first signal. The first signal is transmitted to the processor of the valve 104 and/or unit 102 to cause the valve 104 to close and/or remain closed—i.e., no beverage is disbursed. A user obstructs the path between the emitter 106 and the receiver 108 (notably without ever having to touch the unit 102 or the device 100) to cause the processor of the receiver 108 to generate the second signal. The second signal is transmitted to the processor of the processor of the valve 104 and/or unit 102 to cause the valve 104 to open and/or remain open—i.e., beverage is disbursed. A user un-obstructs the path between the emitter 106 and the receiver 108 (notably without ever having to touch the unit 102 or the device 100) by removing the finger or object from the path to cause the processor of the receiver 108 to generate the first signal. The first signal is transmitted to the processor of the valve 104 and/or unit 102 to cause the valve 104 to close—i.e., beverage is not disbursed.

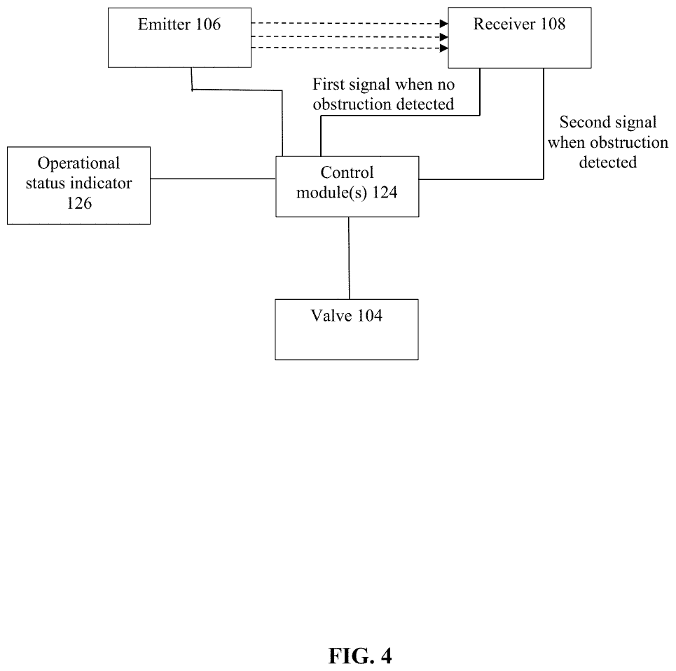

Referring to FIG. 4, the device 100 can include a control module 124, which can be a separate processor (separate from the emitter processor and the receiver processor) or software installed on said processor. As noted herein, generally, when a first signal is received by a processor of the valve 104 or unit 102, the processor of the valve 104 or unit 102 causes the valve 104 to close and/or remain closed until another condition is met. Generally, when a second signal is received by a processor of the valve 104 or unit 102, the processor of the valve 104 or unit 102 causes the valve 104 to open and/or remain open until another condition it met. The control module 124 modifies this operation. In particular, the control module 124 can impose delays in switching of the valve 104 upon receiving the first or second signals, impose automatic shut-offs, etc. The delays can be used to ensure reliable operation of the device 100 and prevent abuse of the device 100 (e.g., prevent users from “playing” with the device 100). For instance, it may be desirable to prevent a user from repeatedly actuating the device 100 and causing excessive switching of the valve 104. It may also be beneficial to switch the valve 104 to an off position after a predetermined amount of time has lapsed since receiving a first signal, regardless of receiving a first signal, so as to mitigate excessing beverage disbursement.

The control module 124 can be configured to intercept the first and second signals being transmitted from the receiver 108 to the valve 104—e.g., the processor of the control module 124 can be in communication with both the processor of the receiver 108 and the processor of the valve 104 and/or the unit 102 such that signals generated from the receiver 108 pass through the control module 124 before being transmitted to the processor for the valve 104 and/or the unit 102.

The control module 124 can include at least one timer circuitry or timer mechanism to impose time delays or time durations on switching.

For instance, the control module 124, upon receiving a first signal or a second signal, can wait a predetermined period of time (e.g., 0.2 seconds, 0.4 seconds, 0.6 seconds, 0.8 seconds, 1.0 second, etc.) before transmitting that signal to the processor of the valve 104 and/or unit 102. This can be referred to as a debounce timer operation. A preferred embodiment uses 120 milliseconds. If the control module 124, within that predetermined time, receives an additional signal, the control module 124 can: 1) transmit the earliest signal received within that time period, 2) transmit the latest signal received within that time period, or 3) default to a first signal transmission (e.g., close the valve 104). If/when the control module 124 receives a signal after that time period lapses, the control module 124 can again impose the time delay as discussed above.

As another example, the control module 124 can impose a time delay after transmitting a signal to the processor of the valve 104 and/or unit 102 before transmitting another signal. Thus, once the control module 124 transmits a first or a second signal, the valve 104 operation corresponding to that signal will remain for a predetermined period of time (e.g., 0.2 seconds, 0.4 seconds, 0.6 seconds, 0.8 seconds, 1.0 second, etc.) regardless of the control module 124 receiving subsequent signals within that predetermined period of time. If/when the control module 124 receives a signal after that time period lapses, the control module 124 can transmit that signal.

As another example, the control module 124 can impose a timer on the amount of time the valve 104 remains open or closed. For instance, once the control module transmits a second signal, the timer can cause the control module 124 to transmit a first signal to close the valve 104 after a predetermined period of time has lapsed (e.g., 10 seconds, 15 seconds, 20 seconds, 25 seconds, etc.), regardless of the receiver 108 generating a second signal to keep the valve 104 open. Thus, the control module 124 can override any second signals being generated by the receiver 108 after that predetermined period of time has lapsed by generating a first signal. The control module 124 can generate the first signal for a predetermined amount of time (e.g., 1 second, 2 seconds, 3 seconds, etc.), generate the first signal until the receiver 108 detects an emission and generates a first signal itself, etc. Generally, beverage dispensing units 102 disburse fluid at a rate of 4 ounces per second. A typical large beverage container size is 64 ounces. As a safety measure, the control module 124 can be configured to transmit a first signal after receiving a second signal for a continuous time period of 20 seconds so as to avoid overflowing the beverage container. Some large beverage container size are 120 ounces. A safety measure for such containers can include the control module 124 being configured to transmit a first signal after receiving a second signal for a continuous time period of 30 seconds so as to avoid overflowing the beverage container. Allowing it to disburse beverage for 20 seconds (64 ounce container) or 30 seconds (120 ounce container) allows for a complete fill of the beverage container with beverage but also avoids overflowing. It also limits any spillage or waste, provided a user actuates the valve 104 without placing a beverage container under the nozzle or continues to activate the valve 104 after removing the beverage container.

Any one or combination of the time delay or time duration schemes discussed herein can be used.

In addition, the device 100 can include at least one operational status indicator 126. This can be an illuminator (e.g., light emitting diode (LED)) located on the device 100 so as to be viewed by a user. The operational status indicator 126 can be a monocolor LED or a bi-color LED. There can be a plurality of monocolor LEDs, each configured to emit a specific color to indicate the operational status of the device 100. Alternatively, there can be one or more bi-color LEDs to achieve the same. For instance, when the valve 104 is open, the control module 124 can cause the operational status indicator 126 to emit a green light to indicate that disbursing is occurring. When the valve 104 is closed, the control module 124 can cause the operational status indicator 126 to emit a red light to indicate that disbursing is not occurring but that the dispensing unit 102 is ready. When there is a time delay or a time duration, the control module 124 can cause the operational status indicator 126 to emit an amber light to indicate a wait period. When the control module 124 causes the valve 104 to default to a closed position, the control module 124 can cause the operational status indicator 126 to emit a flashing red light to indicate that a fault has occurred. Other color schemes and flashing light schemes can be used, and it is understood that the ones described herein are exemplary.

Any of the processors disclosed herein can be an integrated circuit or other electronic device (or collection of devices) capable of performing an operation on at least one instruction including, without limitation, a reduced instruction set core (RISC) processor, a complex instruction set (CISC) processor, a microcontroller unit (MCU) processor, a central processing unit (CPU) processor, a graphical processing unit (GPU), a digital signal processor (DSP), etc. Any of the processors can be part of a printed circuit board (PCB). The processor can be hardware, software, or a combination of both. The processor can be scalable, parallelizable, optimized for multi-thread processing capabilities, etc. Various functional aspects of the processor may be implemented solely as software or firmware associated with the processor. An exemplary processor can be a Ttiny10-TS8R or similar processor type device. In addition, any of the processors can be potted to reduce or eliminate water and liquid intrusion.

Any of the processors disclosed herein can be optionally associated with a memory. Embodiments of the memory can include a volatile memory store (such as RAM), non-volatile memory store (such as ROM, flash memory, etc.) or some combination of the two. For instance, the memory can include, but is not limited to, RAM, ROM, EEPROM, flash memory or other memory technology CDROM, DVD, or other optical storage, magnetic cassettes, magnetic tape, magnetic disk storage or other magnetic storage devices, or any other medium which can be used to store the desired information and which can accessed by the processor. According to exemplary embodiments, the memory can be a non-transitory computer-readable medium. The term “computer-readable medium” (or “machine-readable medium”) as used herein is an extensible term that refers to any medium or any memory, that participates in providing instructions to the processor for execution, or any mechanism for storing or transmitting information in a form readable by a machine (e.g., a computer). Such a medium may store computer-executable instructions to be executed by a processing element and/or control logic, and data that is manipulated by a processing element and/or control logic, and may take many forms, including but not limited to, non-volatile medium, volatile medium, and transmission media.

Transmission media includes coaxial cables, copper wire and fiber optics, including the wires that include or form a bus. Transmission media can also take the form of acoustic or light waves, such as those generated during radio-wave and infrared data communications, or other form of propagated signals (e.g., carrier waves, infrared signals, digital signals, etc.). Forms of computer-readable media include, for example, magnetic medium, optical medium, physical medium, a RAM, a PROM, and EPROM, a FLASH-EPROM, any memory chip or cartridge, or any other medium from which a computer can read.

Instructions for implementation of any of the methods disclosed herein can be stored on the memory in the form of computer program code. The computer program code can include program logic, control logic, or other algorithms that may or may not be based on artificial intelligence (e.g., machine learning techniques, artificial neural network techniques, etc.).

Table 1 provides exemplary hardware component requirements/specifications.

TABLE 1
Exemplary Hardware Component Requirements/Specifications

| | |
|---|---|
| CPU PCB | Small on-board processor required for debounce |
| Requirement | and safety shut off |
| Input Power | 24VAC—From Line class 2 transformer/Can float |
| | high or low a bit |
| | Metal Oxide Varisto (MOV) for protection |
| | Resettable Fuse |
| Output | 24VAC @ 1.8 Amp (inrush 3.9 Amps or 5 Amps |
| | @ 1 ms) |
| LED(s) Customer | 3 × Bi Color LEDs—Red/Green |
| Feedback | |
| Timing Specs | The IR modulation occurs at approximately 1 kHz |
| Active Timing | “On time” from activation to the Triac firing is 20 |
| | ms/Turn off timing is 50 ms. |
| Power Test Points | Test points for GND, Vcc, 24VAC |
| Firmware Update(s) | PC Pads for updating Via Jtag type device |
| IR Emitter PCB | IR Emitter—IR LED/SMT/Gull Wing or similar |
| Sensor PCB | IR Sensor—“Interrupter Sensor”/IR |
| | Photocell/SMT Gull Wing or similar |
| Performance Specs | 1.28 million consecutive activations without failure |
| | Operational after being dropped from a height of |
| | 48″ |
| | Able to retrofit onto an existing valve in less than |
| | 15 minutes |
| | Compliant to the specifications laid out in NSF-18 |
| | Dispenses within 120 ms of cup being placed |
| | below nozzle |
| | Will not suffer any permanent damage or loss in |
| | performance after being subjected to a sanitization |
| | solution of 100 ppm chlorine |
| Additional PCB | PCB 1—Controller/Black Solder Mask |
| Specs | PCB 2—IR LED/“emitter side”— RED Solder |
| | Mask |
| | PCB 3—IR Photo Diode—“Receiver side”—Blue |
| | Solder Mask |
| Connector J1* | 6 pin Right Angle Header |
| | PIN Assignment: |
| | PIN 1—Output to 24VAC Coil 1 |
| | PIN 2—Output to 24VAC Coil 2 |
| | PIN 3—ValidFill V24ACL1—Soda Head |
| | Switch/Legacy 24VACL1 |
| | PIN 4—ValidFill Soda Head Switch |
| | PIN 5—ValidFill Soda Valve Coil |
| | Pin 6—ValidFill V24ACL2—Soda Valve |
| | Coil/Legacy 24VACL2 |
| | *Additionally, place solder pads for 20 Gauge wire |
| | to correspond to the connector in case we go with |
| | direct solder wiring. |

It should be understood that modifications to the embodiments disclosed herein can be made to meet a particular set of design criteria. For instance, the number of or configuration of components or parameters of the various embodiments may be interchangeably used to meet a particular objective.

It will be apparent to those skilled in the art that numerous modifications and variations of the described examples and embodiments are possible in light of the above teachings of the disclosure. The disclosed examples and embodiments are presented for purposes of illustration only. Other alternative embodiments may include some or all of the features of the various embodiments disclosed herein. For instance, it is contemplated that a particular feature described, either individually or as part of an embodiment, can be combined with other individually described features, or parts of other embodiments. The elements and acts of the various embodiments described herein can therefore be combined to provide further embodiments.

It is the intent to cover all such modifications and alternative embodiments as may come within the true scope of this invention, which is to be given the full breadth thereof. Additionally, the disclosure of a range of values is a disclosure of every numerical value within that range, including the end points. Thus, while certain exemplary embodiments of the device and methods of making and using the same have been discussed and illustrated herein, it is to be distinctly understood that the invention is not limited thereto but may be otherwise variously embodied and practiced within the scope of the following claims.

What is claimed is:

1. A touchless valve device, comprising:
an emitter configured to emit an emission;
a receiver configured to detect the emission, the receiver positioned within an emission path of the emitter;
wherein the receiver is configured to:
upon detection of the emission by the receiver, the receiver generates a first signal;
generate a second signal when the receiver does not detect the emission; and
transmit the first signal and/or the second signal to a processor that controls a valve.

2. The touchless valve device of claim 1, wherein the emitter includes an optical generator configured to generate an optical emission, and the receiver includes an emission sensor configured to detect the optical emission.

3. The touchless valve device of claim 2, wherein the optical generator generates an emission within the infrared spectrum.

4. The touchless valve device of claim 2, wherein the optical generator generates an emission that includes radiation at 940 nm.

5. The touchless valve device of claim 1, wherein:
the touchless valve device includes a central member having an emitter end and a receiver end, the emitter end configured to house the emitter, and the receiver end configured to house the receiver.

6. The touchless valve device of claim 5, wherein:
the emitter end includes a protrusion extending from the central member; and
the receiver end includes a protrusion extending from the central member.

7. The touchless valve device of claim 2, wherein:
the touchless valve device includes a central member having an emitter end and a receiver end, the emitter end configured to house the emitter, and the receiver end configured to house the receiver;
the emitter end includes a protrusion extending from the central member configured to house the optical generator; and
the receiver end includes a protrusion extending from the central member configured to house the emission sensor.

8. The touchless valve device of claim 5, wherein the touchless valve device includes a planar member extending from the central member.

9. The touchless valve device of claim 1, further comprising:
a control module configured to receive the first signal and/or the second signal from the receiver, wherein the control module transmits the first signal and/or the second signal to the processor that controls the valve as opposed to the receiver transmitting the first signal and/or the second signal to the processor that controls the valve;
wherein the control module includes a timer mechanism configured to: delay transmission of the first signal and/or the second signal to the processor; and/or
set a time limit for the operational state of the valve.

10. The touchless valve device of claim 9, wherein:
wherein the control module, upon receiving the first signal and/or the second signal from the receiver, waits a predetermined period of time before transmitting the first signal and/or the second signal to the processor.

11. The touchless valve device of claim 10, wherein:
wherein the control module, upon receiving the first signal and/or the second signal from the receiver, waits 120 milliseconds before transmitting the first signal and/or the second signal to the processor.

12. The touchless valve device of claim 9, wherein:
wherein the control module, after transmitting the first signal and/or the second signal from the receiver, waits a predetermined period of time before transmitting a subsequent first signal and/or second signal generated by the receiver to the processor.

13. The touchless valve device of claim 9, wherein:
wherein the control module, after transmitting the second signal to the processor, transmits a first signal to the processor when no first signal has been generated by the receiver within a predetermined time period after the control module transmitted the second signal to the processor.

14. The touchless valve device of claim 13, wherein:
wherein the predetermined time period ranges from 20 seconds to 30 seconds.

15. The touchless valve device of claim 1, further comprising:
an operational status indicator configured to indicate the operational status of the valve.

16. The touchless valve device of claim 15, wherein:
the operational status of the valve is closed when the first signal is being transmitted to the processor that controls the valve; and
the operational status of the valve is open when the second signal is being transmitted to the processor that controls the valve.

17. The touchless valve device of claim 15, wherein the operational status indicator includes at least one illuminator.

18. A touchless valve beverage dispensing unit, comprising:
a beverage dispensing unit including a processor configured to control a valve, the valve configured to control flow of beverage;
a touchless valve actuator, comprising:
an emitter configured to emit an emission;
a receiver configured to detect the emission, the receiver positioned within an emission path of the emitter;
wherein the receiver is configured to:
upon detection of the emission by the receiver, the receiver generates a first signal;
generate a second signal when the receiver does not detect the emission; and
transmit the first signal and/or the second signal to the processor that controls the valve.

19. The touchless valve beverage dispensing unit of claim 18, wherein upon receiving the first signal, the processor generates a command signal to close the valve.

20. The touchless valve beverage dispensing unit of claim 18, wherein upon receiving the second signal, the processor generates a command signal to open the valve.
